(19) United States
(12) Patent Application Publication
(10) Pub. No.: US 2025/0118113 A1
(43) Pub. Date: Apr. 10, 2025

(54) VEHICLE REMOTE MONITORING SYSTEM

(71) Applicant: Wesley Wyatt Norris, Joliet, IL (US)

(72) Inventor: Wesley Wyatt Norris, Joliet, IL (US)

(21) Appl. No.: 18/483,152

(22) Filed: Oct. 9, 2023

(51) Int. Cl. G07C 5/00; G06V 20/56; G06V 20/59

(52) U.S. Cl. CPC G07C 5/008; G06V 20/56; G06V 20/59

(57) ABSTRACT

The present disclosure discloses a vehicle monitoring system that includes a geolocation determination unit, one or more vehicle cameras, a vehicle control unit and an on-board computer. The on-board computer obtains a real-time geolocation of a vehicle from the geolocation determination unit, images of an interior portion and an exterior portion of the vehicle from the vehicle cameras, and real-time vehicle operating parameters from the vehicle control unit. The on-board computer further transmits the real-time geolocation, the images of the interior portion and the exterior portion of the vehicle, and the real-time vehicle operating parameters to an external communication device or a server at a predefined frequency or continuously. The external communication device or the server stores the information received from the on-board computer in a local memory or cloud.

### BACKGROUND OF THE INVENTION

### Field of the Invention

The present invention relates generally to a vehicle remote monitoring system, and more particularly to a computer-controlled remote monitoring system of a vehicle configured to monitor real-time vehicle information and transmit the vehicle information to a remote communication device.

### Description of the Related Art

Accessibility to private and public vehicles have transformed people's lives considerably in the last few decades. Public transport vehicles, such as taxis, buses, etc. are regularly used by users in their day-to-day lives. Further, with the advent of e-commerce, fleet vehicles have gained considerable popularity in recent years, and the usage of fleet vehicles is expected to grow exponentially in the US in the years to come. Furthermore, many modern vehicles enable users to use their vehicles not only for day-to-day transit, but also for adventure sports, off-road expeditions, etc.

While modern vehicles include many safety features, there are instances when the vehicle users desire additional safety features in their vehicles or require assistance from rescue teams when their vehicles are involved in accidents. For example, a user on an off-road adventure trip may desire assistance if the user's vehicle is involved in an accident in a remote location and no local support is immediately available. Moreover, fleet operators or public transport coordinators desire to track movements of their vehicles and perform remedial actions on time, if one of their vehicles needs assistance.

Conventional vehicles and systems installed in the vehicles are not fully equipped to assist users in scenarios where the users need assistance. Delay in assistance may lead to material loss or even human life loss. While conventional vehicles or systems may be suitable for the particular purposes employed, they would not be as suitable for the purposes of the present invention as disclosed hereafter. None of such conventional systems disclose the unique structures and advantages of the present disclosure.

Accordingly, there is a need for a system that assists vehicle users in obtaining remote assistance, and for fleet operators and public transport coordinators to conveniently track their vehicles.

Embodiments of the present disclosure provide for a novel vehicle remote monitoring system and method as described and defined in the description below and in the annexed claims which provide for improved efficiency and effectiveness in order to conveniently and more effectively monitor vehicles.

### SUMMARY OF THE INVENTION

The following presents a simplified summary of the present disclosure in a simplified form as a prelude to the more detailed description that is presented herein.

In accordance with embodiments of the invention, there is provided a vehicle monitoring system (“system”). The system includes a geolocation determination unit configured to determine a real-time geolocation of a vehicle. The system further includes one or more vehicle cameras configured to capture images of an interior portion and an exterior portion of the vehicle. Furthermore, the system includes a vehicle control unit configured to determine real-time vehicle operating parameters. The system additionally includes an on-board computer communicatively coupled with the geolocation determination unit, the vehicle cameras and the vehicle control unit.

In certain embodiments, the on-board computer is configured to obtain the real-time geolocation, the images of the interior portion and the exterior portion of the vehicle, and the real-time vehicle operating parameters. The on-board computer is further configured to transmit the real-time geolocation, the images of the interior portion and the exterior portion of the vehicle, and the real-time vehicle operating parameters to an external communication device at a predefined frequency (or continuously).

In some embodiments, the system further includes a transceiver. The on-board computer transmits the real-time geolocation, the images of the interior portion and the exterior portion of the vehicle, and the real-time vehicle operating parameters to the external communication device wirelessly via the transceiver.

In certain embodiments, the geolocation determination unit is a Global Position System (GPS) transceiver. Further, the system includes a power connector configured to power the on-board computer via a power supply.

In accordance with another embodiment of the invention, there is provided a vehicle monitoring method. The method includes obtaining, by an on-board computer, a real-time geolocation of a vehicle from a geolocation determination unit. The method further includes obtaining, by the on-board computer, images of an interior portion and an exterior portion of the vehicle from one or more vehicle cameras. Further, the method includes obtaining, by the on-board computer, real-time vehicle operating parameters from a vehicle control unit. The method additionally includes transmitting, by the on-board computer, the real-time geolocation, the images of the interior portion and the exterior portion of the vehicle, and the real-time vehicle operating parameters to an external communication device at a predefined frequency (or continuously).

In accordance with yet another embodiment of the invention, there is provided a non-transitory computer-readable storage medium having instructions stored thereupon which, when executed by a processor, cause the processor to obtain a real-time geolocation of a vehicle from a geolocation determination unit. The processor is further configured to obtain images of an interior portion and an exterior portion of the vehicle from one or more vehicle cameras, and obtain real-time vehicle operating parameters from a vehicle control unit. The processor is further configured to transmit the real-time geolocation, the images of the interior portion and the exterior portion of the vehicle, and the real-time vehicle operating parameters to an external communication device at a predefined frequency (or continuously).

The present disclosure discloses a vehicle monitoring system and method. The system transmits real-time vehicle geolocation, images of vehicle interior and/or exterior portions and real-time vehicle operating parameters (e.g., on-board diagnostics (OBDII), etc.) to a remote server or a communication device. In some embodiments, the remote server or the communication device is associated with rescue teams, police, insurance firms, fleet operators, public transport coordinators, and/or the like. The operators/coordinators review and analyze the information obtained from the system, and take remedial actions if the vehicle user requires assistance. For example, if the vehicle is involved in an accident and the vehicle operating parameters indicate that the vehicle air-bags are deployed, the operators/coordinators may understand that the vehicle user needs immediate assistance, and perform remedial actions accordingly. The system also assists police, vehicle owners, insurance firms, etc. to track stolen vehicles or “car jackers” by tracking vehicle's location and obtaining vehicle images.

In certain embodiments, the vehicle operating parameter (i.e., OBDII) information transmitted by the system includes “codes” that the remote server or cloud stores, or are used by a vehicle repair shop or roadside assistance for diagnostic repairs if the vehicle is disabled. In this case, repair parts are obtained or arranged in advance, since the system transmits the vehicle operating parameters in real-time continuously. The geolocation, images and vehicle operating parameters transmitted by the system further assists fleet operators to track the fleet vehicles, track any missing vehicles, track movement of any vehicle that is late in the delivery route, etc. The information also assists ride sharing firms or food delivery firms to live-stream their riders and food delivery. The information also assists public transport coordinators to visually keep track of vehicle drivers and occupants.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is an example environment in which techniques and structures for providing the systems and methods disclosed herein is implemented;

FIG. 2 is an example flowchart depicting a vehicle monitoring method, in accordance with embodiments of the invention; and

FIG. 3 is a block diagram of an example vehicle monitoring system, in accordance with embodiments of the invention.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

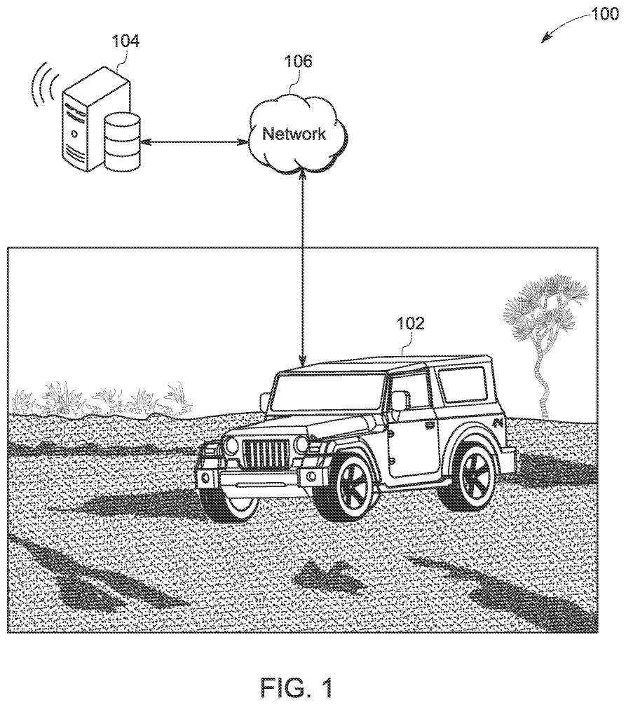

FIG. 1 is an example environment 100 in which techniques and structures for providing the systems and methods disclosed herein is implemented. The environment 100 includes a vehicle 102 and a server 104, communicatively coupled with each other via a network 106.

In some embodiments, the server 104 is associated with a fleet operator, a rescue team, police, an insurance firm, a public transport coordinator, and/or the like. In other embodiments, the server 104 is a communication device associated with a family member or friend of a user driving the vehicle 102.

The network 106 is, for example, a communication infrastructure including the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, cellular technologies, etc.

The vehicle 102 is any passenger or commercial vehicle such as, for example, a car, a crossover vehicle, a truck, a van, a minivan, a taxi, a bus, etc. In the exemplary embodiment depicted in FIG. 1, the vehicle 102 is travelling on an off-road terrain (e.g., a desert); however, the present disclosure is not limited to the aspect of the vehicle 102 being driven in an off-road terrain.

In certain embodiments, the vehicle 102 includes a vehicle monitoring system (“system”) that continuously (or at a predefined frequency) monitors vehicle information, and transmits the monitored vehicle information to the server 104 (and the server 104 and/or a cloud storage may store the received vehicle information). In some embodiments, the system includes a plurality of units including, but not limited to, a geolocation determination unit, one or more vehicle cameras, a vehicle control unit, an on-board computer, a transceiver, a power connector, vehicle engine, one or more batteries, and/or the like, which may be communicatively coupled with each other. In certain embodiments, the power connector is configured to power the on-board computer and other vehicle components and/or system components via a power supply, e.g., from the vehicle engine and/or the batteries.

In some embodiments, the geolocation determination unit is a Global Position System (GPS) transceiver that is configured to determine a real-time geolocation of the vehicle 102, and continuously transmit the real-time geolocation to the on-board computer.

In some embodiments, the vehicle cameras are front dash camera, rear dash camera, interior dash camera, and/or the like. The vehicle cameras are configured to capture images of an interior portion and an exterior portion of the vehicle 102, and continuously send the captured images to the on-board computer.

The vehicle control unit is configured to determine real-time vehicle operating parameters, e.g., (OBDII), etc., and continuously send the real-time vehicle operating parameters to the on-board computer. The real-time vehicle operating parameters indicates whether the vehicle 102 is travelling or stopped, vehicle's real-time speed, operational status of one or more vehicle components, e.g., doors, lights, air bags, etc. For example, the real-time vehicle operating parameters indicates whether the air bags are deployed, thus indicating that the vehicle 102 is involved in an accident.

In operation, the on-board computer obtains the real-time geolocation from the geolocation determination unit, the images of the interior portion and the exterior portion of the vehicle 102 from the vehicle cameras and the real-time vehicle operating parameters from the vehicle control unit, and transmits the information to the transceiver. The transceiver wirelessly transmits the obtained information to the server 104 via the network 106 continuously or at a predefined frequency, and the server 104 (or a cloud storage) stores the obtained information.

The operators and/or coordinators operating the server 104 use the information obtained from the transceiver to monitor the movement and condition of the vehicle 102, and perform remedial actions (if required). For example, if the vehicle 102 is involved in an accident and the vehicle operating parameters indicate that the vehicle air-bags are deployed, the operators/coordinators may understand that the vehicle user needs immediate assistance, and perform remedial actions accordingly. The obtained information also assists police, vehicle owners, insurance firms, etc. to track stolen vehicles or “car jackers” by tracking vehicle's location and obtaining vehicle images.

The information is also used by a vehicle repair shop or roadside assistance for diagnostic repairs if the vehicle 102 is disabled. In this case, repair parts are obtained or arranged in advance, since the on-board computer/transceiver transmits the vehicle operating parameters in real-time. The geolocation, images and vehicle operating parameters transmitted by the on-board computer/transceiver further assists fleet operators to track the fleet vehicles, track any missing vehicles, track movement of any vehicle that may be late in the delivery route, etc. The information also assists ride sharing firms or food delivery firms to live-stream their riders and food delivery. The information also assists public transport coordinators to visually keep track of vehicle drivers and occupants.

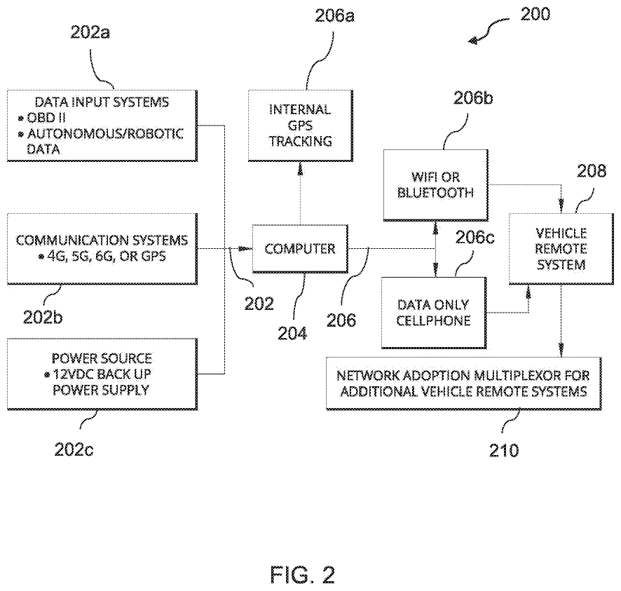

FIG. 2 is an example flowchart depicting a vehicle monitoring method 200, in accordance with embodiments of the invention. FIG. 2 is described with continued reference to FIG. 1. The following process is exemplary and not confined to the steps described hereafter. Moreover, alternative embodiments may include more or less steps than are shown or described herein and may include these steps in a different order than the order described in the following example embodiments.

At step 202, the method 200 includes obtaining, by an on-board system computer 204 (or computer 204), the real-time vehicle operating parameters from the vehicle control unit or from one or more data input systems, as shown by a block 202a in FIG. 2. The real-time vehicle operating parameters include OBD II data, autonomous/robotic data, images of interior and/or exterior portions of the vehicle 102, and/or the like. At step 202, the computer 204 further obtains additional information (e.g., GPS data, etc.) from one or more communication systems including, but not limited to, 4G, 5G, 6G, LTE, etc. systems, GPS systems, and/or the like, as shown by a block 202b in FIG. 2. At step 202, the computer 204 additionally obtains power from a power source (e.g., via the power connector), as shown by a block 202c in FIG. 2. In some embodiments, the power source may be a 12V DC back up power supply of the vehicle 102.

At step 206, the method 200 includes transmitting, by the computer 204, the obtained real-time vehicle operating parameters and/or the additional information to one or more external systems. In some embodiments, the computer 204 transmits the obtained GPS data to an internal GPS tracking system, shown as a block 206a in FIG. 2. In further embodiments, the computer 204 transmits the real-time vehicle operating parameters and/or the additional information to a vehicle remote system 208, which transmits the information to the server 104 (not shown in FIG. 2). In certain embodiments, the computer 204 transmits the real-time vehicle operating parameters and/or the additional information to the vehicle remote system 208 via WiFi or Bluetooth (shown as a block 206b in FIG. 2) or data only cellphone (shown as a block 206c in FIG. 2, which includes 4G/5G/6G communication protocols). In further embodiments, the vehicle remote system 208 includes a network adoption multiplexer 210 that enables the vehicle remote system 208 to connect with additional vehicle remote systems.

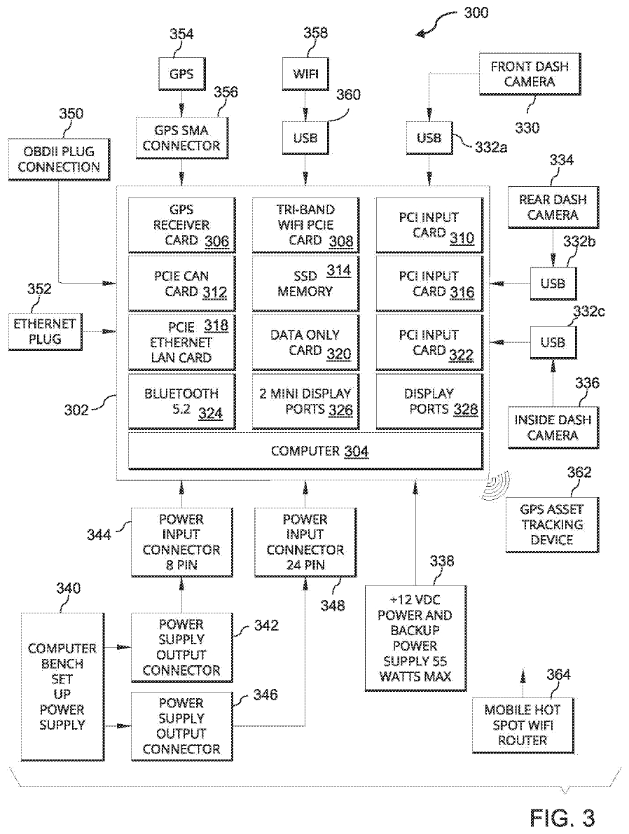

FIG. 3 is a block diagram of an example vehicle monitoring system 300 (or system 300), in accordance with embodiments of the invention. The system 300 is same as the vehicle monitoring system described above in conjunction with FIG. 1. In some embodiments, the system 300 is installed in the vehicle 102. In other embodiments, the system 300 is part of the vehicle 102.

The system 300 includes a computing system 302 having a computer 304 and a plurality of additional units that may be part of the computer 304 or separate from the computer 304. The computer 304 is same as the computer 204 described above in conjunction with FIG. 2.

In some embodiments, the plurality of additional units in the computing system 302 includes, but is not limited to, a GPS receiver card 306, a tri-band WiFi PCIE card 308, a PCI input card 310, a PCIE CAN card 312, an SSD memory 314, a PCI input card 316, a PCIE Ethernet LAN card 318, a data only card 320, a PCI input card 322, Bluetooth 5.2 interface 324, one or more (e.g., two) mini display ports 326, display ports 328, and/or the like.

In some embodiments, the computing system 302 is connected to a vehicle front dash camera 330 via a USB 332a and the PCI input card 310, a vehicle rear dash camera 334 via a USB 332b and the PCI input card 316, and a vehicle inside dash camera 336 via a USB 332c and the PCI input card 322. The computing system 302 obtains images of the interior portion and the exterior portion of the vehicle 102 via the vehicle front dash camera 330, the vehicle rear dash camera 334 and the vehicle inside dash camera 336.

In some embodiments, the computing system 302 draws power from a 12V DC power and backup power supply of 55 Watts (maximum), shown as a block 338 in FIG. 3. In additional embodiments, the computing system 302 draws power from a computer bench set-up power supply 340. Specifically, the computer bench set-up power supply 340 provides power to the computing system 302 via a power supply output connector 342 and a power input connector 8 PIN 344, and/or via a power supply output connector 346 and a power input connector 24 PIN 348.

The computing system 302 is further connected to an OBD II plug connection 350 via the PCIE CAN card 312. The computing system 302 obtains real-time vehicle operating parameters from the vehicle control unit (not shown) via the OBD II plug connection 350 and the PCIE CAN card 312. In certain embodiments, the computing system 302 is further connected to an Ethernet plug 352 via the PCIE Ethernet LAN card 318.

In some embodiments, the computing system 302 is further connected to a GPS receiver or tracker 354 via a GPS SMA connector 356 and the GPS receiver card 306. The computing system 302 is further connected to a WiFi router 358 via a USB 360 and the tri-band WiFi PCIE card 308.

In certain embodiments, the computing system 302 is further connected wirelessly to a GPS asset tracking device 362 and a mobile hotspot WiFi router 364.

In some embodiments, the computer 304 includes a processor and a memory (not shown), which assists the computer 304 to perform one or more actions as disclosed in the present disclosure. The memory stores programs in code and/or stores data for performing various operations in accordance with the present disclosure. The processor is configured and/or programmed to execute computer-executable instructions stored in the memory for performing various functions in accordance with the disclosure. Consequently, the memory is used for storing code and/or data code and/or data for performing operations in accordance with the present disclosure.

In one or more embodiments, the processor is disposed in communication with one or more memory devices. The memory can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory is one example of a non-transitory computer-readable medium and stores programs in code and/or stores data for performing various operations in accordance with the disclosure. The instructions in the memory can include one or more separate programs, each of which can include an ordered listing of computer-executable instructions for implementing logical functions.

Further, operation system (OS) and anti-virus malware are pre-installed in the computer 304 by the system manufacturer and/or other IT professionals installing the system 300 in the vehicle 102.

A person ordinarily skilled in the art will appreciate that the system 300 depicted in FIG. 3 includes additional components/units including, but not limited to, one or more additional memory or data storage devices, additional power sources, adaptors, cables, network cards, screws, display ports, heat sink/fan, male/female connectors, antennas, infrared night vision cameras, and/or the like. These additional components/units are not depicted in FIG. 3 for the sake of simplicity and conciseness.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A vehicle monitoring system comprising:
a geolocation determination unit configured to determine a real-time geolocation of a vehicle;
a vehicle camera configured to capture images of an interior portion and an exterior portion of the vehicle;
a vehicle control unit configured to determine real-time vehicle operating parameters; and
an on-board computer communicatively coupled with the geolocation determination unit, the vehicle camera and the vehicle control unit, wherein on-board computer is configured to:
obtain the real-time geolocation, the images of the interior portion and the exterior portion of the vehicle, and the real-time vehicle operating parameters; and
transmit the real-time geolocation, the images of the interior portion and the exterior portion of the vehicle, and the real-time vehicle operating parameters to an external communication device at a predefined frequency.

2. The vehicle monitoring system of claim 1 further comprising a transceiver, wherein the on-board computer transmits the real-time geolocation, the images of the interior portion and the exterior portion of the vehicle, and the real-time vehicle operating parameters to the external communication device wirelessly via the transceiver.

3. The vehicle monitoring system of claim 1, wherein the geolocation determination unit comprises a Global Position System (GPS) transceiver.

4. The vehicle monitoring system of claim 1 further comprising a power connector configured to power the on-board computer via a power supply.

5. A vehicle monitoring method comprising:
obtaining, by an on-board computer, a real-time geolocation of a vehicle from a geolocation determination unit;
obtaining, by the on-board computer, images of an interior portion and an exterior portion of the vehicle from a vehicle camera;
obtaining, by the on-board computer, real-time vehicle operating parameters from a vehicle control unit; and
transmitting, by the on-board computer, the real-time geolocation, the images of the interior portion and the exterior portion of the vehicle, and the real-time vehicle operating parameters to an external communication device at a predefined frequency.

6. The vehicle monitoring method of claim 5, wherein transmitting the real-time geolocation, the images of the interior portion and the exterior portion of the vehicle, and the real-time vehicle operating parameters comprises transmitting the real-time geolocation, the images of the interior portion and the exterior portion of the vehicle, and the real-time vehicle operating parameters wirelessly via a transceiver.

7. The vehicle monitoring method of claim 5, wherein the geolocation determination unit comprises a Global Position System (GPS) transceiver.

8. The vehicle monitoring method of claim 5 further comprising powering the on-board computer via a power connector and a power supply.

9. A non-transitory computer-readable storage medium having instructions stored thereupon which, when executed by a processor, cause the processor to:
obtain a real-time geolocation of a vehicle from a geolocation determination unit;
obtain images of an interior portion and an exterior portion of the vehicle from a vehicle camera;
obtain real-time vehicle operating parameters from a vehicle control unit; and
transmit the real-time geolocation, the images of the interior portion and the exterior portion of the vehicle, and the real-time vehicle operating parameters to an external communication device at a predefined frequency.

10. The non-transitory computer-readable storage medium of claim 9, wherein the geolocation determination unit comprises a Global Position System (GPS) transceiver.
